(19) United States
(12) Patent Application Publication
(10) Pub. No.: US 2008/0043482 A1
(43) Pub. Date: Feb. 21, 2008

(54) Adjustment System For Headlights

(75) Inventors: Andreas Leitretter, Denkendorf (DE); Frank Tebbe, Ertingen (DE); Lukas Schwenkschuster, Burgstetten (DE)

Correspondence Address: REISING, ETHINGTON, BARNES, KISSELLE, P.C., P O BOX 4390, TROY, MI, 48099-4390, US

(73) Assignee: SCHEFENACKER VISION SYSTEMS GERMANY GMBH, Schwaikheim (DE)

(21) Appl. No.: 11/677,088

(22) Filed: Feb. 21, 2007

(30) Foreign Application Priority Data
Feb. 21, 2006 (DE) 10 2006 008 363.6

(51) Int. Cl. F21V 14/02

(52) U.S. Cl. 362/508

(57) ABSTRACT

The invention relates to a headlight adjustment device for adjusting a light module in reference to a headlight housing, which comprises at least two linear drive units, by which the light module can be pivoted around a rotary bearing at least in two perpendicular directions. For this purpose the rotary bearing is supported by a linear drive unit mounted in the headlight housing at least in a moment-stiff manner. Additionally, the light module is connected to the headlight housing with a univalent support compensating gravity. With the present invention a headlight adjustment device has been developed for a spatial adjustment of the light module.

The invention relates to a headlight adjustment system for adjusting a light module in reference to a headlight housing, comprising at least two linear drive units, by which the light module can be pivoted around a rotary bearing at least in two directions perpendicular to each other.

A good illumination of the road is necessary for high driving safety at twilight and darkness. For the purpose, e.g., the width of the light of the headlights is adjusted dependent on the load, variations in the body based on acceleration and braking processes, etc. When driving around a curve the pivotal angle of the headlights is controlled depending on the steering angle, for example. In order to further improve the illumination of the road modern vehicles are additionally provided with a turning light, for example, which laterally widens the illuminated area in front of the vehicle depending on the turning direction. When a vehicle moves at high speed when turning it can only follow a wide radius. Here, a lesser lateral illumination is necessary. When the vehicle drives at low speeds, though, the curve driven when turning may be of a short radius. The illuminated area on the road should be laterally widened, here.

Form DE 101 31 068 A1 a headlight adjustment device is known. It allows an adjustment of the inclination as well as a curve light adjustment. The area illuminated by the turning light is not adjustable with this headlight adjustment device.

The present invention is therefore based on the object to develop an adjustment device for headlights for a spatial adjustment of the light module.

This object is attained in the features of the primary claim. For this purpose, a rotary bearing is supported via an at least moment-stiff linear drive unit mounted in the headlight housing. Additionally, the light module is connected to the headlight housing via a univalent support compensating gravity.

Additional details of the invention are discernible from the sub claims and the following description of the exemplary embodiments shown schematically.

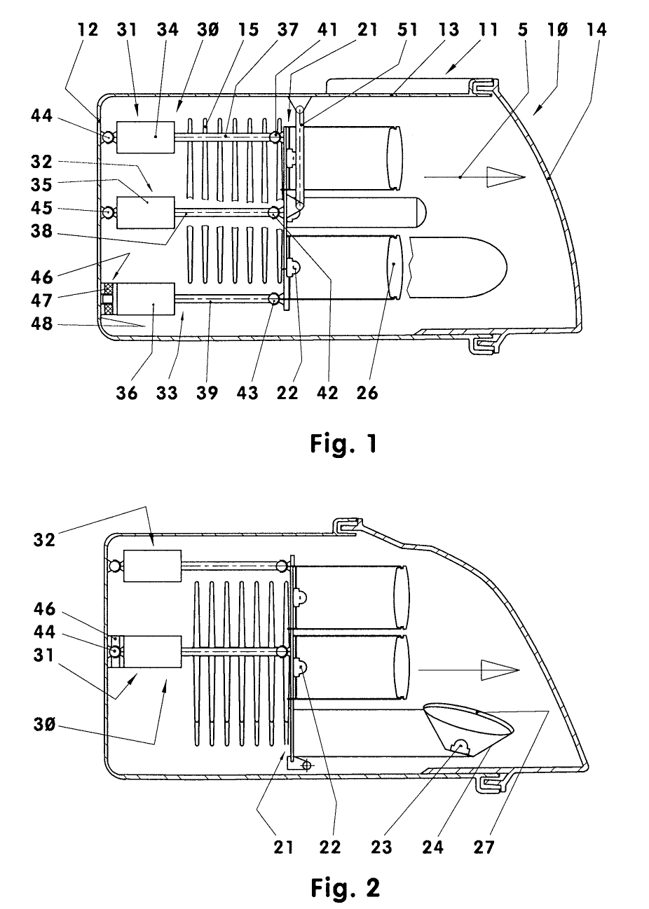

FIG. 1: side view of a headlight with the side wall removed;

FIG. 2: top view of the headlight of FIG. 1 with the roof removed;

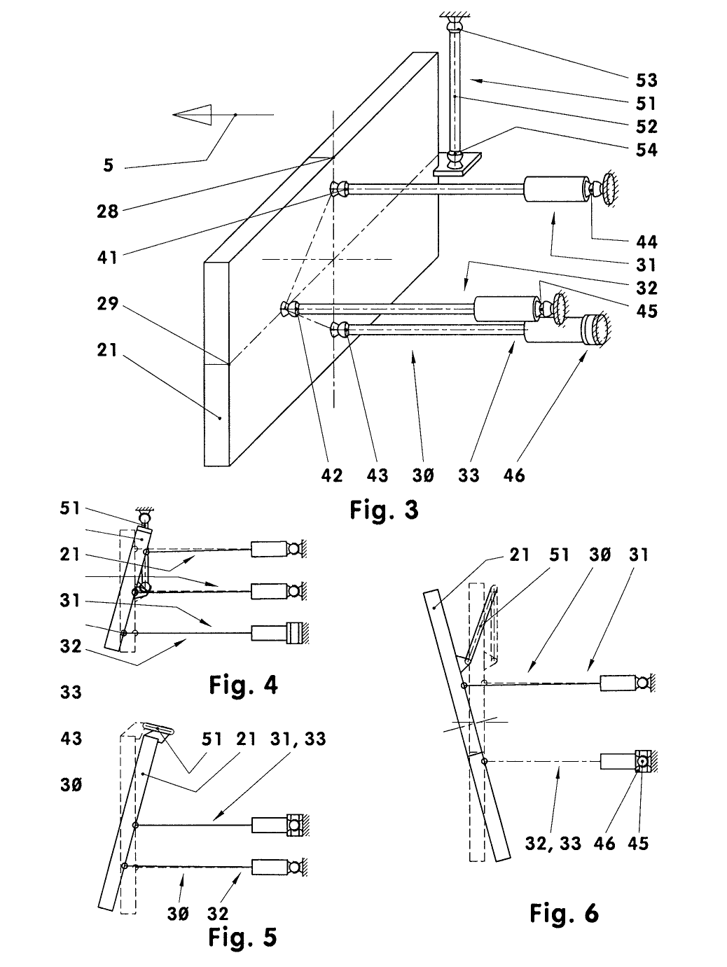

FIG. 3: schematic representation of a headlight adjustment device;

FIG. 4: adjustment for headlights for leveling;

FIG. 5: adjustment for headlights when driving around curves;

FIG. 6: adjustment for headlights when turning;

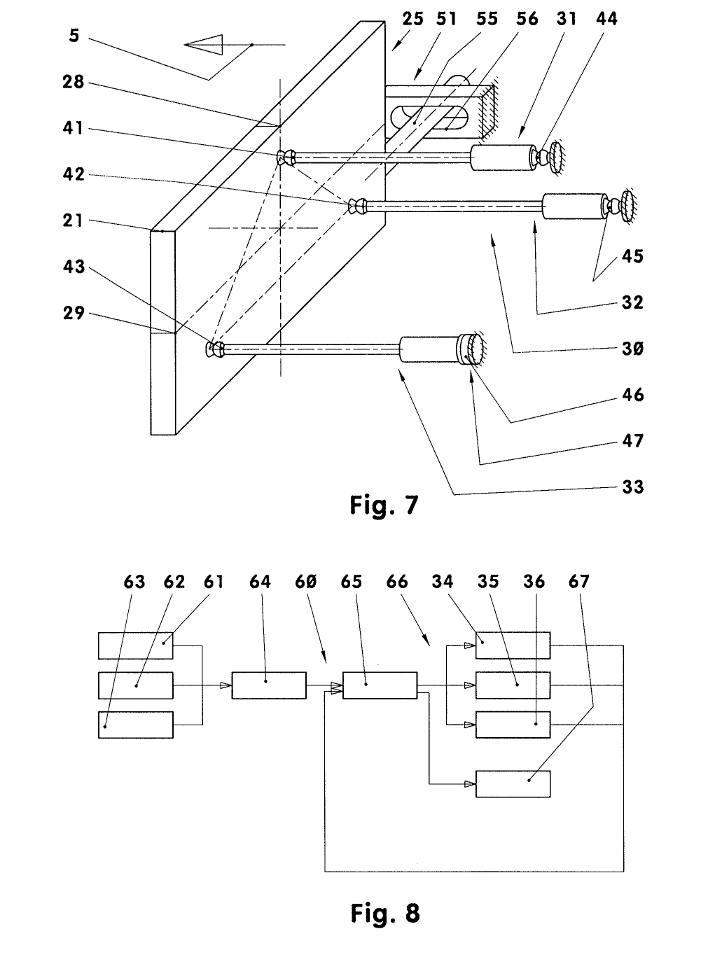

FIG. 7: headlight adjustment device with a horizontal guidance;

FIG. 8: diagram of the control of the drive units.

FIG. 1 and 2 show a lateral and a top view of a headlight (10) with a sidewall removed and/or the top removed. The headlight (10) is the left front headlight of a motor vehicle, for example. It comprises a headlight housing (11), which is closed in the direction of the light beam (5) via a headlight glass (14) limiting the vehicle contour, for example. The individual headlight (10) may comprise several headlight housings (11). Additionally, the headlight housing (11) may be divided into several sections.

The headlight housing (11) is, for example, a light module (21) with, for example, seven light sources (22, 23) and allocated optic lenses (26, 27) being arranged. The headlight (10) may comprise several light modules (21), which are arranged in a joint headlight housing (11). In this exemplary embodiment, the light sources (22) are arranged in two vertical lines side-by-side to each other with three light sources (22) each. These light sources (22) create, for example, low beams, high beams, etc. For example, at the interior wall of the headlight housing (11) the light source (23) is arranged, which, e.g., is oriented as a component of a turning light (24) in the direction of the left vehicle side.

The individual light sources (22, 23) are light diodes, for example. In order to remove the heat developing during the operation of the light sources (22, 23) the light module (21) is provided, e.g., with a cooling body (15), which is connected to the light sources (22, 23) in an at least thermally conducting manner.

The light module (21) is positioned in the headlight housing (11) via a headlight adjustment device (30). In an embodiment of the headlight (10) having several light modules (21) it may comprise one or more headlight adjustment devices (30), by which the light modules (21) can be modified or adjusted individually or jointly. The headlight adjustment device (30) comprises, for example, three linear drive units (31-33). They are, e.g., linear adjustment motors with one motor each (34-36) and a transfer element to be deployed in the linear direction (37-39), e.g., spindles (37-39). The spindles (37-39) are supported at the light module (21) in a linked manner, for example in three bearings (41-43). The motors (34-36) are supported at the rear wall (12) of the headlight housing (11) in the bearings (44-46). Other linear electric, electromagnetic, pneumatic, or hydraulic drive units are also possible. Additionally, rotary motors may be used, which, for example, drive a coupling rod.

The bearings (41-43) at the light module (21) stretch a triangle, cf. FIG. 3. Two bearings (41, 43) are supported, for example, on the virtual vertical central longitudinal level (28) of the light module (21), a bearing (42) is here arranged on the virtual horizontal central longitudinal level (29). The bearings (41-43) are embodied as ball-and-socket joints, for example. They each include, e.g. a ball head arranged at the spindles (37-39), which is located in a socket arranged at the light module (21). These bearings (41-43) can also be embodied as elastically deforming bearings, as a combination of pivotal and/or rotary joints, etc. Additional dampening elements are also possible. The bearings (41-43) are provided with three rotary degrees of freedom in this exemplary embodiment, however, the lateral forces are transferred. Therefore, these bearings (41-43) are here trivalent.

The bearings (44) and (45), in which the drive units (31) and (32) are supported in the headlight housing (11), are built like the bearings (41-43) at the light module (21), for example.

The bearings (46) supporting the drive unit (33) in the headlight housing (11), is at least embodied in a moment stiff-manner. Torque around the bearing (46) is transferred to the headlight housing (11). In this exemplary embodiment an elastomer body (47) is arranged between the motor (36) and the rear wall (12), which, e.g., can only be elastically deformed in the lateral direction in reference to the mounting areca (48). Using this elastomer body (47), oscillations may be dampened, for example, which are excited during braking and accelerating the vehicle.

The motor (36) can be mounted directly at the rear wall of the headlight housing (11), for example. The latter is then mounted to the motor vehicle via oscillation-dampening elements, for example.

In this exemplary embodiment a support (51) is arranged between the top (13) of the headlight housing (11) and the light module (21). It comprises, for example, a tensile and pressure rod (52), which is supported in trivalent bearings (53, 54) at the top (13) and at the light module (21), respectively.

The tensile and pressure rod (52) is arranged in this exemplary embodiment such that it hangs vertically in a neutral central position of the light module (21). The bearing (54) lies, for example, in the horizontal central longitudinal level (29) of the light module (21). During normal operation the support (51) acts like a univalent tensile rod, which compensates gravity of the light module (21). This way, it prevents a distortion of the light module (21) under the influence of gravity.

Instead of a rod (52), a rope, wire, a flexible rod, etc. may also be used as the support (51).

FIGS. 3 through 6 show schematically a headlight adjustment device (30). FIG. 3 shows a headlight adjustment device (30), e.g., a left vehicle headlight with a light module (21) in a central position. The corresponding vehicle has a normal load and drives straight ahead, for example. The three drive units (31-33) are positioned, for example, horizontally and parallel in reference to each other. The drive unit (31) trivalently supported in the headlight housing (11) is arranged in the upper third of the central vertical longitudinal level (28), for example. The drive unit (32), also trivalently supported in the headlight housing (11), is arranged, e.g., in the left third of the horizontal central longitudinal level (29), seen in the drive direction. The drive unit (33) is arranged in the lower third of the vertical central longitudinal level (28), in this exemplary embodiment, which is connected to the headlight housing (11) in a moment-stiff manner. The support (51) is here mounted at the side of the light module (21) facing the interior of the vehicle.

FIG. 4 shows the adjustment of the inclination of the light module (21). This FIG. 4 shows as an interrupted line the side view of the right module (21) and the headlight adjustment device (30) of FIG. 3 in the central position. In a position tilted, e.g., by 15 degrees, these components are shown as continuous lines. The inclination shown here is considerably higher than the usual inclinations of the light module (21) amounting to +/−2 degrees,

In order to tilt the light module (21) clockwise, for example, the lower drive unit (33) is deployed and the upper drive unit (31) is retracted. The central drive unit (32) remains idle, for example.

When deploying the lower drive unit (33) the bearing (43) is displaced horizontally in the direction of the light reflection (5). The light module (21) pivots around this bearing (43), which here forms a rotary bearing (43). The central bearing (42) pivots around said bearing (45) having the radius equivalent to the distance from the corresponding bearing (45) at the side of the housing. Here, the central bearing (42) is displaced downwards only slightly. The seeming pivotal axis of the light module (21) is therefore at least almost positioned in the horizontal central longitudinal level (29) of the light module (21). When pivoting the light module (21) the upper bearing (41) is displaced downwards against the direction of the light reflection (5). The support (51) is deflected only slightly at the common adjustment angles of normal drive operation.

When adjusting the inclination counter-clockwise the drive units (31, 33) are addressed in the opposite direction.

In order to adjust the inclination of the light module (21), for example, the upper (31) or the lower drive unit (33) remains idle. Then, in order to adjust the inclination the respectively two other drive units (32, 33; 31, 32) are activated. In order to adjust the inclination all drive units (31-33) may be adjusted.

FIG. 5 shows a top view to the light module (21) and the headlight adjustment device (30). In this FIG. 5, in an interrupted line the central position is shown and in a continuous line the light module (21) pivoted to the right by 15 degrees, for example. Here, the pivotal angle shown for clarity reasons is greater than the common pivotal angle in motor vehicles amounting to +/−2 degrees.

When driving in a right curve, for example, the drive units (31) and (33) remain idle located over top of each other in this representation. The central drive unit (32) is deployed and pivots the light module (21) around the rotary beating (43). The support (51) is slightly deflected in the common pivotal angles, for example counter-clockwise in reference to the direction of the light deflection (5). The virtual pivotal axis extends through the rotary bearing (43) and is at least approximately located in the vertical central longitudinal level (28).

In order to pivot the light module (21) in the opposite direction the central drive unit (32) is, e.g., retracted.

The light module may also be pivoted by leaving the central drive unit (32) idle and operating the two other drive units (31, 33). The virtual pivotal axis then is displaced, e.g., parallel to the vertical central longitudinal level in the direction of the beating (42), in which the central drive unit (32) is supported. All drive units (31-33) may be operated for pivoting.

FIG. 6 shows a diagonal view of the light module (21) and the headlight adjustment device (30). In this view, for example, the drive units (32) and (33) are located over top of each other. In this FIG. 6, the light module (21) and the headlight adjustment device (30) are shown as interrupted lines in a central position. Here, the continuous line shows the light module (21) and the headlight adjustment device (30) in a turn light (24) tilted downwards, cf. FIG. 2. In order to pivot the light module (21) with the turn light (24), for example, the drive units (32) and (33) remain idle. The drive unit (31) is deployed and here the light module (21) pivots around a virtual pivotal axis, which is at least approximately in the connecting line of the bearing (42) and the rotary bearing (43). The support (51) is deflected in the direction of the light reflection (5).

When pivoting the light module (21) in the opposite direction the drive unit (31) is retracted. Of course, this pivotal motion may also be realized via the other two drive units (32, 33) or by operating all drive units (31-33).

The light module (21) can be displaced in the longitudinal direction of the headlight (10). For this purpose, all drive units (31-33) are deployed or retracted simultaneously. This way, for example, the optical features of the headlight (10) or its optic impression can be changed. The use of different light modules is possible, which are displaced in reference to each other, for example.

This motion processes described individually can be interfered. The light module (21) may be displaced along a curved path, for example. The illumination of the road may therefore, e.g., be controlled depending on the drive-dynamic dimensions such, that the driver receives the optimum illumination. For example, if the driver wants to turn at a slow speed the vehicle can drive a curve with a short radius. The turn light (24) illuminates a wide area. When, e.g., at an exit from a highway the blinker is operated, due to the expected long radius of the curve, the turn light (24) is illuminated only over a narrow range laterally to the area, which is illuminated by the other light sources (13).

The closer the virtual pivotal axes are to the vertical (28) and/or horizontal central longitudinal level (29) the less space the light module (21) requires for the inclination and for pivoting. The position of the bearings (41-43) at the light module (21) is not critical, Therefore, the headlight adjustment device (30) can be adjusted to the geometric frame conditions inside the headlight (10).

The rotary bearing (43) at the light module (21) may be arranged in the sectional straight of the vertical (28) and the horizontal central longitudinal level (29). For example, then the second bearing is located below the rotary bearing (43) in the vertical central longitudinal level (28). The third bearing is located in the horizontal central longitudinal level (29), e.g., at the location of the bearing (42) in FIG. 3. In order to change the inclination of the light module (21), then the drive unit is adjusted, which effects the above-mentioned second bearing on the light module (21). In order to pivot the light module (21) when driving around a curve the drive unit is operated, which acts onto the above-mentioned third bearing. When the low beams shall be pivoted, for example, the second and the third drive unit remain unaffected. The drive unit acting upon the rotary bearing (43) is deployed. The light module (21) then pivots, e.g., around an axis formed by the second and third bearing. In order to adjust the light module (21) in the longitudinal direction all three drive units are operated. In this exemplary embodiment the bearings at the light module (21) as well as the pivotal bearings at the headlight housing (11) can be provided with two pivoting levels. These two pivoting levels then are positioned, e.g., perpendicular in reference to each other and perpendicular to the levels stretched by the bearings at the light module (21) and/or by the bearings at the headlight housing (11).

In FIG. 7 a headlight adjustment device (30) is shown, which has a horizontal guidance (55, 56) as a support (51). The three bearings (41-43) stretch a triangular area at the light module (21). Here, for example, one bearing (41) is located in the vertical central longitudinal level (28) of the light module (21) above the horizontal central longitudinal level (29), the second bearing (42) and the rotary pole bearing (43) are located below the horizontal central longitudinal level (29) at both sides of the vertical central longitudinal level (28). At a face (25) of the light module (21) pointing away from the rotary bearing (43) a guidance rod (55) is arranged, e.g., which is supported in a guidance of elongated holes (56) mounted at the headlight housing (11). The guidance rod (55) is arranged, for example, on the same horizontal level parallel to the horizontal central longitudinal level (29) at which the two bearings (42, 43) are located.

In order to adjust the inclination of the light module (21), for example, the drive units (32, 33) remain idle. The drive unit (31) is retracted or deployed depending on the necessary inclination, in which the light module (21) pivots around an axis, which at least approximately runs through the bearings (42, 43). The guidance rod (55) is distorted in the oblong hole (56) and displaced only slightly.

In order to adjust the curve light, for example the drive unit (31) remains idle. The drive units (32, 33) are operated in opposite directions. The light module (21) pivots around a vertical axis, with the guidance rod (55) in the oblong hole (56) being horizontally displaced as a radial around the pivotal axis.

In order to adjust the low beams, for example, all three drive units (31-33) are activated. The light module (21) then pivots, e.g., around a pivotal axis, which then extends in the view of FIG. 7 through the second and fourth quadrant and the guidance (55, 56). The guidance rod (55) is distorted and/or displaced only slightly in the guidance (56) during this pivoting.

In this exemplary embodiment the bearings (41-43, 44, 45) may also be embodied with two pivotal degrees of freedom only. These bearings (41-43, 44, 45) are then embodied quadrilateral, for example.

The headlight adjustment device (30) can then also be embodied differently than the one described. For example, combinations of exemplary embodiments of FIGS. 3 through 7 are possible. The components mounted in the headlight housing (11) may also be indirectly connected thereto, for example via intermediate pars, dampened elements, etc.

As described, the joints (41-43, 44, 45) can be embodied as joints with two or three degrees of freedom, e.g., as ball-and-socket joints, fully suspended joints, etc. However, here it is also possible to combine such a joint comprising two or three individual joints having one degree of freedom each.

The individual linear drive unit (31-33) forms a driven driving joint, for example, with a perpendicular degree of freedom in the spatial transmission described here.

The headlight adjustment device (30) may be designed such that the drive units (31, 32) are mounted in the headlight housing (11) similarly to the drive unit (33). Then, between the drive units (31, 32) and the light module (21) coupling members are arranged each, which are supported at both sides, e.g., trivalently, at the drive unit (31, 32) and at the light module (21).

The headlight adjustment device (30) or individual elements of the headlight adjustment device (30) may also be arranged in the space between the headlight glass (14) and the light module (21).

FIG. 8 shows a diagram of the control (60) of the headlight adjustment device (30). It comprises a position circuit (66), with its adjustment member being the evaluation device (65) and its distance of control being the adjustment motor (34-36). Each of the motors (34-36) has a distance measuring system, for example, in order to forward the actual value of the deployment distance to the evaluation device (65). In order to determine the target values for the adjustment motors (34-36), for example the measurements of axis sensors (61), steering angle sensors (62), and acceleration sensors (63) can be compiled in a CAN-bus (64) and forwarded to the evaluation unit (65). During the regulations, for example, the driver is informed via a control light (67).

### LIST OF REFERENCE CHARACTERS

5 direction of light reflection
10 headlight
11 headlight housing
12 rear wall of (11)
13 top of (11)
14 headlight glass
15 cooling body
21 light module
22 light sources
23 light source
24 turn light
25 face of (21)
26, 27 optic lenses
28 vertical central longitudinal axis
29 horizontal central longitudinal axis
30 headlight adjustment device
31-33 linear drive units
34-36 motors
37-39 transfer elements, spindles
41, 42 bearings at (21)
43 bearings at (21), rotary bearing
44-46 bearings at (11)
47 elastic bearings, elastomer body
48 mounting surface
51 support
52 tensile and pressure rod
53, 54 bearing
55 guidance rod
56 oblong hole
60 control
61 axle sensors
62 steering angle sensors
63 acceleration sensors
64 CAN-bus
65 evaluation device
66 position circuit
67 control light

1. A headlight adjustment device for adjusting a light module in reference to a headlight housing comprising at least two linear drive units, by which the light module is pivotal at least in two directions perpendiculars to each other around a rotary bearing, characterized in that
the rotary hearing (43) is supported by a linear drive unit (33) mounted at least moment-stiff in the headlight housing (11), and
that the light module (21) is connected to the headlight housing (11) via a univalent support (51) compensating gravity.

2. A headlight adjustment device according to claim 1, characterized in that each drive unit (31-33) comprises a distance measuring system.

3. A headlight adjustment device according to claim 1, characterized in that the drive units (31-33) are at least supported in the headlight housing (11) via elastic bearings (47).

4. A headlight adjustment device according to claim 1, characterized in that the bearings (41-43) at the light nodule (21) comprise elastic deformable bearings.

5. A headlight adjustment device according to claim 1, characterized in that the bearing (51) is a support rod (52), supported in a jointed fashion at the headlight housing (11) and at the light module (21).

6. A headlight adjustment device according to claim 1, characterized in that the three drive units (31-33) can be addressed individually.

7. A headlight adjustment device according to claim 1, characterized in that the light module (21) comprises a turn light (24).
